(19) United States
(12) Patent Application Publication
(10) Pub. No.: US 2005/0078360 A1
(43) Pub. Date: Apr. 14, 2005

(54) Telescope body and telescope provided with the telescope body

(75) Inventor: Makoto Mogamiya, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/962,566

(22) Filed: Oct. 13, 2004

(30) Foreign Application Priority Data
Oct. 14, 2003 (JP) 2003-353814

(51) Int. Cl. G02B 5/20; F21V 9/06; G02B 17/00; G02B 21/00; G02B 23/00

(52) U.S. Cl. 359/361; 359/399

(57) ABSTRACT

A telescope body includes an objective optical system; a focusing mechanism provided with a focus ring which is operated for achieving focusing and a focus lens which is moved along the optical axis by operating the focus ring; a CCD as an imaging device for capturing an image formed by at least the objective optical system and the focus lens; and a UV cut filter for eliminating light having wavelengths in the vicinity of ultraviolet light contained in light that enters the CCD. A telescope is constructed from the telescope body and an eyepiece provided on the telescope body. According to this telescope, it is possible to prevent color blur due to longitudinal chromatic aberration from appearing in an image taken by the imaging device. Further, this telescope can be manufactured at a relatively low cost.

### BACKGROUND OF THE INVENTION

1. Field of the Invention

The present invention relates to a telescope body and a telescope provided with the telescope body.

2. Description of the Prior Art

There is known a telescope (ground-based telescope) with digital imaging capability, which can take an electronic image that is the same as an object image seen through an eyepiece (see Japanese Utility Model No. 3074642, for example). Such a telescope with digital imaging capability has a structure in which light that has passed through an objective optical system and a focus lens is divided by a beam splitter into two, and then one is directed to an eyepiece optical system and the other is directed to an imaging device (image pickup device) such as a CCD or the like.

In general, in telescopes including such a telescope with digital imaging capability, an achromatic lens is used as an optical lens, and it is designed such that longitudinal chromatic aberration for light having wavelengths in the range of 500 to 600 nm (that is, for green light to orange light) is reduced. However, in this case, longitudinal chromatic aberration for light having wavelengths shorter than 500 nm and longer than 600 nm (that is, for blue and red light) still remains. Such remaining longitudinal chromatic aberration (which is called “secondary spectrum”) can be tolerated in lenses for normal cameras. However, since the effect of longitudinal chromatic aberration increases in proportion to focal length, such longitudinal chromatic aberration gives rise to a serious problem in a long-focus optical system such as a telescope with digital imaging capability.

In a case where a human observes an object through an eyepiece with the naked eye, occurrence of significant longitudinal chromatic aberration for blue and red lights does not give rise to a problem. This is because the sensitivity to brightness of the human eye (that is, luminosity) depends on wavelengths of lights even in a case where the intensities of the lights are the same. Specifically, the human eye is most sensitive to green light but is not so sensitive to blue and red lights. That is, the human eye perceives green light as brightest light, while the human eye is relatively hard to perceive blue light and red light. Therefore, in a case where a human directly observes an object through an eyepiece, a human does not recognize longitudinal chromatic aberration for blue and red lights even if significant longitudinal chromatic aberration occurs.

On the other hand, since an imaging device is sensitive not only to green light but also to blue and red lights, it suffers from longitudinal chromatic aberration for blue and red lights. Usually, since an IR cut filter is provided upstream from the imaging device, the effect of longitudinal chromatic aberration for red light is not so conspicuous. However, longitudinal chromatic aberration for blue light appears as blue blur or purple blur in an electronic image taken by the imaging device.

As described above, a human does not recognize longitudinal chromatic aberration when directly observes an object through an eyepiece, but a conventional telescope with digital imaging capability having an imaging device involves a problem that blue blur or purple blur caused by longitudinal chromatic aberration appears in an image taken by the imaging device. Blue blur or purple blur can be reduced by using special glass such as a low-dispersion lens capable of reducing longitudinal chromatic aberration for blue light, but such glass is so expensive that the manufacturing cost of such a telescope with digital imaging capability is increased.

### SUMMARY OF THE INVENTION

It is therefore an object of the present invention to provide a telescope body and a telescope provided with the telescope body which can be manufactured at a relatively low cost while being capable of preventing color blur due to longitudinal chromatic aberration from appearing in an image taken by an imaging device.

In order to achieve the above mentioned object, the present invention is directed to a telescope body, which comprises an objective optical system; a focus adjuster provided with a focus adjusting member which is operated for achieving focusing and a focus lens which is moved along the optical axis by operating the focus adjusting member; an imaging device for capturing an image formed by at least the objective optical system and the focus lens; and a UV eliminator for eliminating light having wavelengths in the vicinity of ultraviolet light contained in light that enters the imaging device.

According to the telescope body of the present invention, it is possible to provide a telescope which is capable of preventing color blur due to longitudinal chromatic aberration from appearing in an imagetakenby an imaging device. Further, this result can be achieved by a structure which can be manufactured with a relatively low cost, thus enabling to avoid a manufacturing cost from being increased.

In the telescope body according to the present invention, it is preferred that the UV eliminator eliminates 50% or more of light having wavelengths of 430 nm or less. This makes it possible to prevent color blur from occurring more reliably.

Further, in the telescope body according to the present invention, it is also preferred that the telescope body further includes a beam splitter which divides light that has passed through the focus lens into an optical path toward an eyepiece optical system and an optical path toward the imaging device, wherein the UV eliminator is provided on the optical path between the beam splitter and the imaging device. This makes it possible to miniaturize the UV eliminator, thus contributing to reducing the manufacturing cost.

Further, in the telescope body according to the present invention, it is also preferred that the telescope body further includes a beam splitter which divides light that has passed through the focus lens into an optical path toward an eyepiece optical system and an optical path toward the imaging device, and an image-forming optical system provided on the optical path between the beam splitter and the imaging device for forming an image on a light-receiving surface of the imaging device based on beams of the light from the beam splitter. This makes it possible to miniaturize the imaging device, thus contributing to downsizing the ground-based telescope.

In this case, it is preferred that the UV eliminator is provided on the optical path between the imaging optical system and the imaging device. This also makes it possible to further miniaturize the UV eliminator, thus contributing to reducing the manufacturing cost.

Furthermore, in the telescope body according to the present invention, it is also preferred that the UV eliminator includes an optical filter provided in the vicinity of a light-receiving surface of the imaging device. This makes it possible for the UV eliminator to have an extremely simple and small structure, thus contributing to further reducing the manufacturing cost.

Moreover, in the telescope body according to the present invention, it is also preferred that the telescope body further includes an optical lowpass filter and/or an IR cut filter provided in the vicinity of a light-receiving surface of the imaging device, wherein the optical filter is laminated on the optical lowpass filter and/or the IR cut filter. This also makes it possible for the UV eliminator to have an extremely simple and small structure, and the assembly thereof can be made easily, thus contributing to further reducing the manufacturing cost.

Moreover, in the telescope body according to the present invention, it is also preferred that an imaging optical system for the imaging device is constructed from all of optical systems arranged between the objective optical system and a light-receiving surface of the imaging device, and the focal length of the imaging optical system is 800 mm or longer converted into 35 mm film format. When the focal length of the imaging optical system is set in the range described above, the effect of the present invention is exhibited conspicuously.

Another aspect of the present invention is directed to a telescope comprising a telescope body as described above and an eyepiece optical system provided on the telescope body.

According to the telescope of the present invention described above, it is possible to provide a telescope which is capable of preventing color blur due to longitudinal chromatic aberration from appearing in an image taken by an imaging device. Further, this result can be achieved by a structure which can be manufactured with a relatively low cost, thus enabling to avoid a manufacturing cost from being increased.

These and other objects, structures and results of the present invention will be apparent more clearly when the following detailed description of the preferred embodiments is considered taken in conjunction with the appended drawings.

### BRIEF DESCRIPTION OF THE DRAWINGS

FIG. 1 is a perspective view which shows the embodiment of a ground-based telescope body according to the present invention and it is seen from the front side.

FIG. 2 is a perspective view of the ground-based telescope body shown in FIG. 1 and it is seen from the rear side.

FIG. 3 is a sectional side view of the ground-based telescope body shown in FIG. 1.

FIG. 4 is a perspective view which shows optical systems of the ground-based telescope according to the present invention.

FIG. 5 is a side view of a prism unit seen from a side opposite to the side shown in FIG. 3.

FIG. 6 is a block diagram of the ground-based telescope body shown in FIG. 1.

FIG. 7 is a sectional side view of a filter unit.

FIG. 8 is a graph which shows spectral transmittance characteristics and spectral sensitivity characteristics.

### DESCRIPTION OF THE PREFERRED EMBODIMENTS

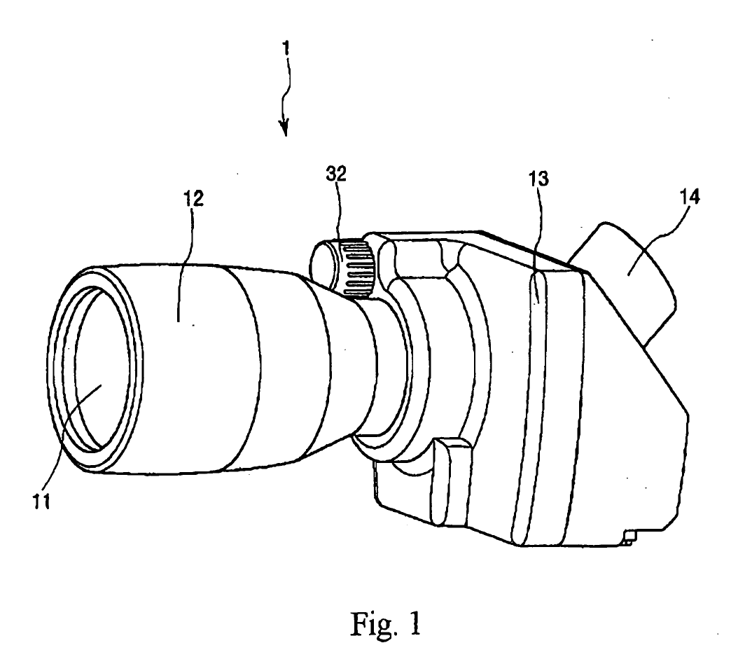

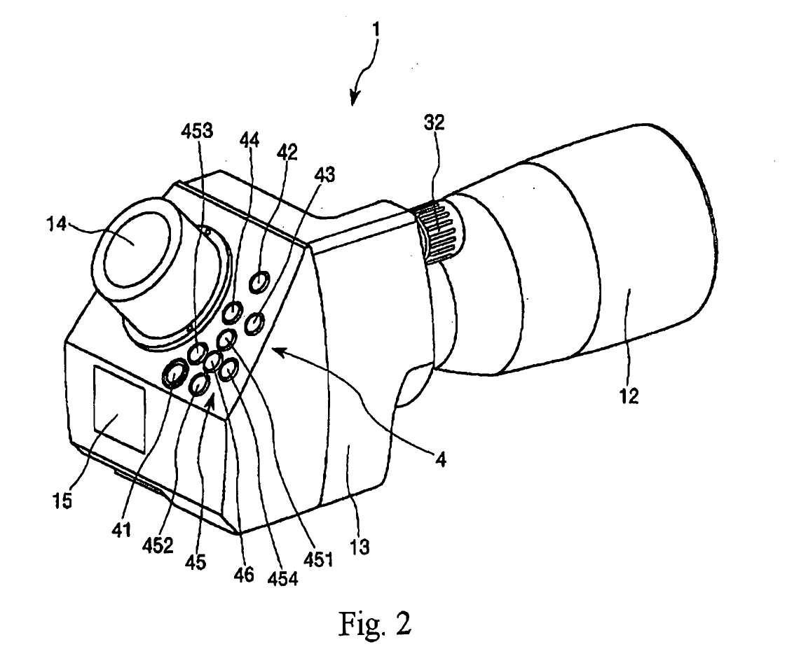

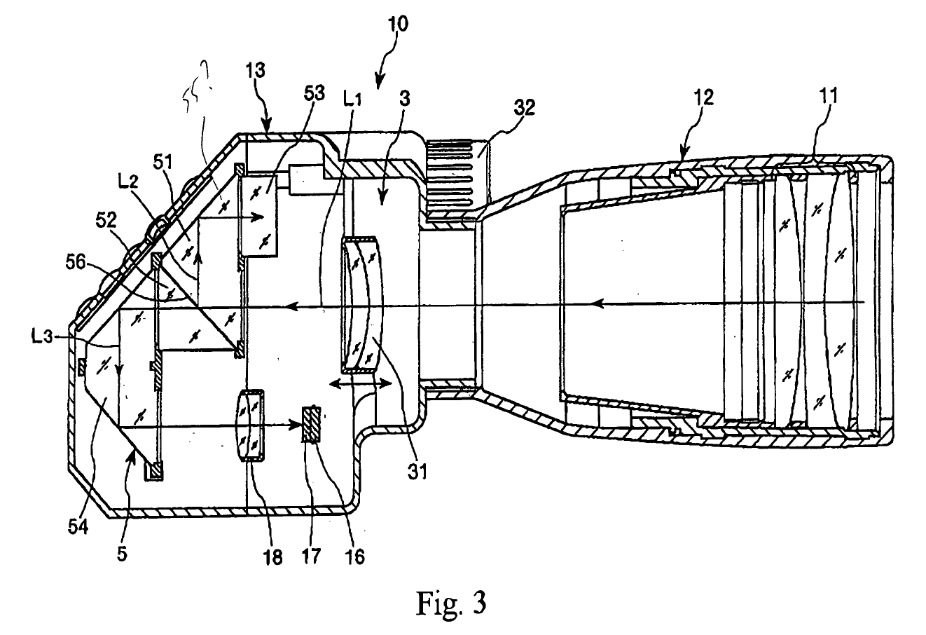

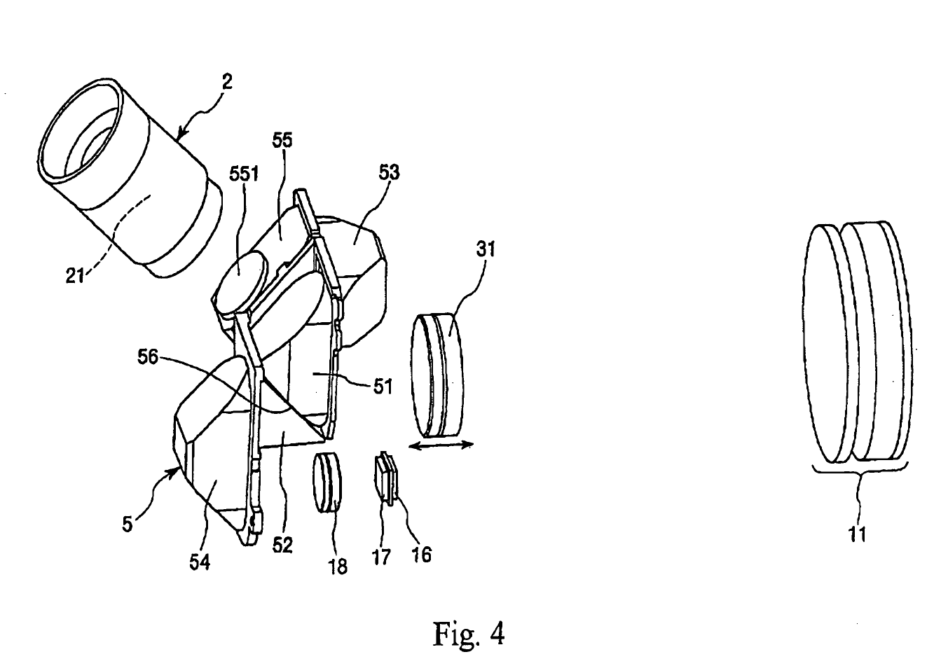

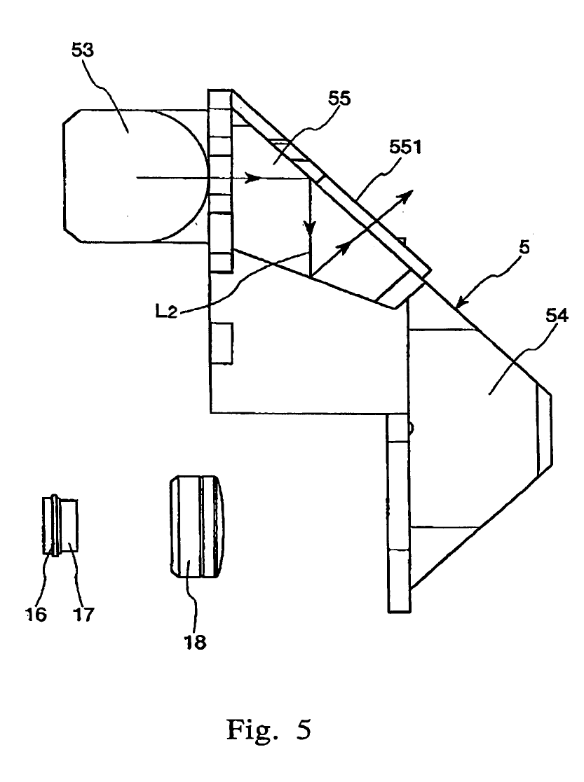

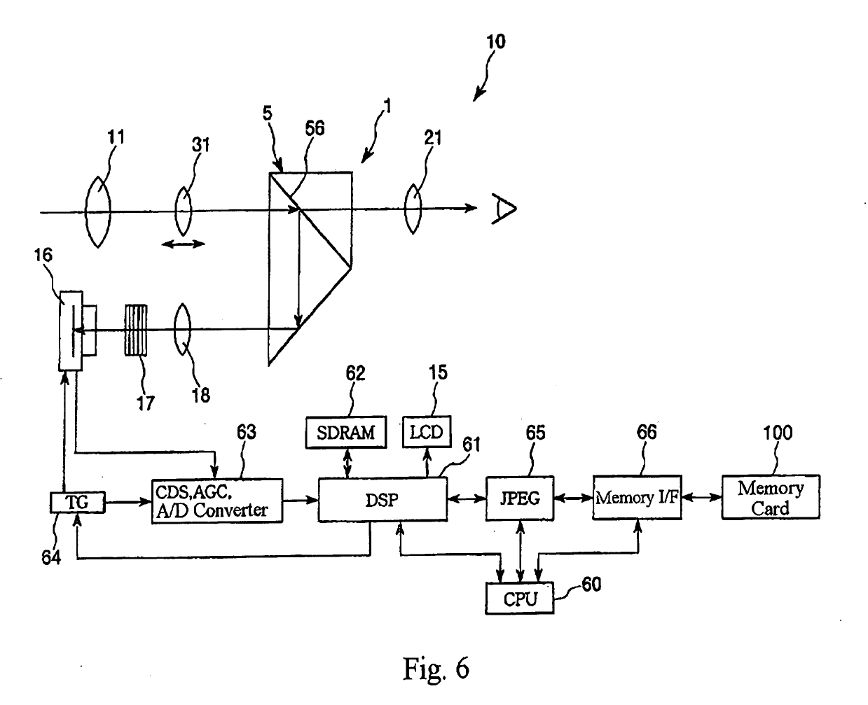

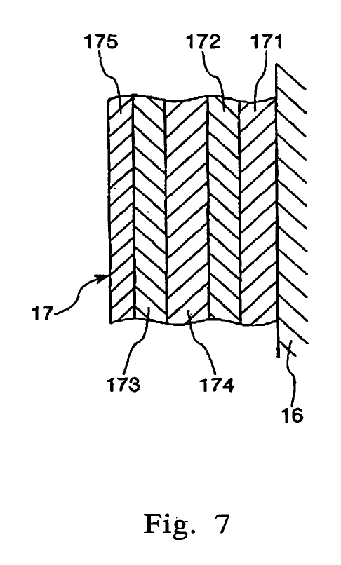

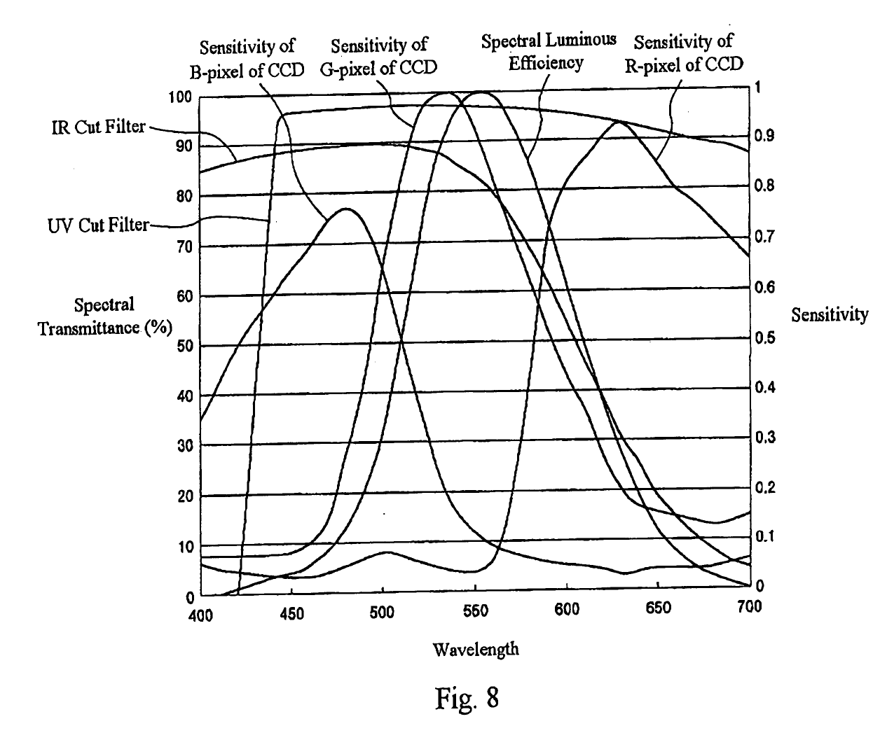

Hereinbelow, a telescope body and a telescope provided with the telescope body according to the present invention will be described in detail with reference to a preferred embodiment shown in the accompanying drawings. FIG. 1 is a perspective view which shows the embodiment of a ground-based telescope body according to the present invention and it is seen from the front side, FIG. 2 is a perspective view of the ground-based telescope body shown in FIG. 1 and it is seen from the rear side, FIG. 3 is a sectional side view of the ground-based telescope body shown in FIG. 1, FIG. 4 is a perspective view which shows optical systems of the ground-based telescope according to the present invention, FIG. 5 is a side view of a prism unit seen from a side opposite to the side shown in FIG. 3, FIG. 6 is a block diagram of the ground-based telescope body shown in FIG. 1, FIG. 7 is a sectional side view of a filter unit, and FIG. 8 is a graph which shows spectral transmittance characteristics and spectral sensitivity characteristics.

A ground-based telescope body 1 according to the present invention shown in these drawings, together with an eyepiece 2, constitutes a ground-based telescope 10. Such a ground-based telescope 10 can be suitably used for watching wild birds and the like.

As shown in FIG. 1, the ground-based telescope body 1 includes a barrel 12 with an objective optical system 11, and a casing 13 provided on the proximal end of the barrel 12. On the upper part of the front surface of the casing 13, a focus ring 32 is rotatably provided.

As shown in FIG. 2, on the rear surface of the casing 13, a cylindrical eyepiece mounting 14 to which the eyepiece 2 can be detachably attached, a display 15, and various operation switches 4 are provided.

As shown in FIG. 4, the eyepiece 2 has an eyepiece optical system 21, and can be detachably attached to the eyepiece mounting 14. The magnification of the ground-based telescope 10 can be changed by replacing the eyepiece 2 with one having a different focal length. Alternatively, a variable-focus eyepiece (that is, a zoom type eyepiece) may be attached to the eyepiece mounting 14.

Although the ground-based telescope 10 shown in the drawings is an angle-type ground-based telescope in which the optical axis of the eyepiece 2 attached to the eyepiece mounting 14 is upwardly tilted at a predetermined angle with respect to the optical axis of the objective optical system 11, the present invention is not limited thereto. The present invention can be applied to a straight-type ground-based telescope in which the optical axis of an eyepiece is parallel to the optical axis of an objective optical system.

The display 15 may be constructed from a liquid crystal display, for example. The display 15 can display a menu screen, a mode select screen, an image taken (captured) by a CCD 16 (which will be described later), and the like.

The operation switches 4 include a power switch 41 to turn the power on or off, a release button 42, a menu button 43, a display button 44 to turn the display 15 on or off, a four-way button 45 to move a cursor or the like on the display 15, and an OK button 46 to confirm a selection. The four-way button 45 is made up of an up button 451, a down button 452, a left button 453, and a right button 454.

As shown in FIG. 3, the objective optical system 11 is provided in the vicinity of the tip end of the barrel 12. Further, a focus lens 31 is provided in the casing 13 so that the focus lens 31 and the objective optical system 11 are coaxially arranged. The focus lens 31 is moved in the direction of the optical axis thereof by operating a focus adjusting member (that is, by rotating the focus ring 32) to achieve focusing. As a focus lens movement mechanism (not shown in the drawings) to convert the rotational motion of the focus ring 32 into the linear motion of the focus lens 31, a cylindrical cam mechanism or a feed screw mechanism can be used, for example The focus lens 31. the focus ring 32, and the focus lens movement mechanism constitute a focus adjuster 3.

In the rear of the focus lens 31 in the casing 13, there is provided a prism unit 5. The prism unit 5 has a first right-angle prism 51, a second right-angle prism 52, a third right-angle prism 53, a fourth right-angle prism 54, and a prism 55.

One of the surfaces with short edges of the first right-angle prism 51 and the surface with long edges of the second right-angle prism 52 are brought into contact with each other to provide a contact surface as a beam splitter 56. As shown in FIG. 4, the prism 55 has a light emitting surface 551 through which light is emitted toward the eyepiece optical system 21 (that is, toward the eyepiece mounting 14).

As shown in FIG. 3, light that has passed through the objective optical system 11 and the focus lens 31 first enters the first right-angle prism 51. An optical path L₁ of the incident light is divided by the beam splitter 56 into an optical path L₂ toward the eyepiece optical system 21 and an optical path L₃ toward the CCD 16 (which will be described later).

Light traveling along the optical path L₂ toward the eyepiece optical system 21 is reflected by the beam splitter 56, and is again reflected by the other surface with short edges of the first right-angle prism 51, to thereby become opposite in direction to the incident light. As shown in FIG. 5, the light traveling along the optical path L₂ is reflected twice by the third right-angle prism 53 so that the direction thereof is again reversed. Then, the light traveling along the light path L₂ is further reflected twice by the prism 55 to be upwardly tilted so that the light is emitted through the light emitting surface 551 toward the eyepiece optical system 21.

The first right-angle prism 51 and the third right-angle prism 53 form an erecting optical system (that is, a Porro prism). By providing the erecting optical system, a user can observe an erect image through the eyepiece 2.

As shown in FIG. 3, light traveling along the optical path L₃ toward the CCD 16 that has passed through the beam splitter 56 enters the fourth right-angle prism 54, and is then reflected twice by the fourth right-angle prism 54 so that the direction thereof is reversed. Then, the light along the optical path L₃ travels toward the front side of the ground-based telescope body 1.

In the casing 13, there are also provided the CCD 16 as an imaging device, an optical filter unit 17, and a reduction optical system 18 as an image-forming optical system.

The CCD 16 is provided so as to receive the light traveling along the optical path L₃, and therefore it can take an image formed by the objective optical system 11 and the focus lens 31. A light-receiving surface of the CCD 16 is arranged so that the CCD 16 can be focused. The CCD 16 is focused at the same time as a user rotates the focus ring 32 to bring an object to be observed into focus while looking the object through the eyepiece 2. By using the ground-based telescope 10 having such a structure as described above, an electronic image that is the same as an observation image seen through the eyepiece 2 can be taken by the CCD 16. In this regard, it is to be noted that the imaging device is not limited to a CCD such as the CCD 16. For example, a CMOS sensor may also be used.

The optical filter unit 17 is provided such that it is in contact with the light-receiving surface of the CCD 16. As shown in FIG. 7, the optical filter unit 17 has optical lowpass filters 171 and 172, an IR cut filter 174, an optical lowpass filter 173, and a UV cut filter 175, and they are laminated on the light-receiving surface in this order.

These optical lowpass filters 171, 172 and 173 are used to reduce spatial frequency components close to a sampling spatial frequency determined by the pixel pitch of the CCD 16 from the spatial frequency of subject light. By providing the optical lowpass filters, it is possible to prevent moiré.

The IR cut filter 174 is used to eliminate infrared wavelength components. By providing the IR cut filter 174, it is possible to prevent the CCD 16 from receiving invisible infrared light. As the IR cut filter 174, one having such spectral transmittance characteristics as shown in FIG. 8 can be used, for example.

The UV cut filter 175 functions as a UV eliminator for eliminating ultraviolet light and light having wavelengths in the near-ultraviolet region (which is visible light). In the present invention, as will be described later in detail, by providing the UV cut filter 175, it is possible to prevent blue blur or purple blur from appearing in an image taken by the CCD 16.

As the UV cut filter 175, a sharp cut filter having such spectral transmittance characteristics as shown in FIG. 8 can be used, for example.

In addition, it is preferred that the UV cut filter 175 can eliminate 50% or more of light having wavelengths of 430 nm or less. By using such a UV cut filter, it is possible to reliably prevent blue blur or purple blur.

The reduction optical system 18 is provided between the fourth right-angle prism 54 and the CCD 16, that is, between the fourth right-angle prism 54 and the optical filter unit 17. Beams of light that have passed through the focus lens 31 travel along the optical path L₃, and are reduced by the reduction optical system 18 so that an image can be formed on the light-receiving surface of the CCD 16.

As has been described above, in the ground-based telescope body 1, all the optical systems including the objective optical system 11 provided between the objective optical system 11 and the light-receiving surface of the CCD 16, that is, the objective optical system 11, the focus lens 31, the beam splitter 56, the reduction optical system 18, and the optical filter unit 17 constitute the imaging optical system of the CCD 16.

It is preferred that the focal length of this imaging optical system is 800 mm or longer converted into 35 mm film format. Here, the focal length converted into 35 mm film format refers to a focal length which allows a subject image to be formed on an effective light-receiving surface of the CCD 16 with the same angle of view as that of a 35 mm silver-salt film camera assuming that the effective light-receiving surface of the CCD 16 has the same area as that of the exposure surface of 35 mm silver-salt film (36 mm×24 mm).

Further, an upper limit for the focal length of this imaging optical system is not set to a specific value. However, from a practical point of view, the focal length of the imaging optical system in the telescope according to the present invention is about 20,000 mm or less converted into 35 mm film format.

As shown in FIG. 6, the ground-based telescope body 1 includes an electrical circuit made up of a CPU (Central Processing Unit) 60 as a control means, a DSP (Digital Signal Processor) 61, an SDRAM (Synchronous Dynamic Random Access Memory) 62, an imaging signal processing circuit 63, a timing generator 64, a JPEG circuit (which is an image data compressing circuit) 65, and a memory interface 66. In addition, in the casing 13, there is provided a slot (not shown in the drawings) into which a memory card (which is a record medium) 100 can be inserted.

The CPU 60 is provided to control the ground-based telescope body 1 overall. For example, the CPU 60 controls photographing, various operations corresponding to the respective operation switches 4, and the like.

The DSP 61 is a processor to control the operation of the CCD 16 and the overall image processing and recording operations, such as generation of image data by the use of pixel signals from the CCD 16, compression of the image data, and recording of the image data onto the memory card 100. The DSP 61 is connected to the CPU 60 so that they can communicate with each other to cooperatively control the ground-based telescope body 1.

The SDRAM 62 has a work area for generation of image data and the like, and an area for the display 15.

Based on the control of the DSP 61, the timing generator 64 outputs sample pulses for the CCD 16 and the image pickup signal processing circuit 63, to thereby control the operations of the CCD 16 and the image pickup signal processing circuit 63.

The display 15 can display a live view image (that is, a monitoring image) taken by the CCD 16 in real time in the following manner. A subject image formed on the CCD 16 is subjected to photoelectric conversion to obtain charge data. In order to generate live view image data, the charge data (signals) is successively read out from the CCD 16 with a predetermined amount of pixels being thinned out, and is subjected to correlation double sampling (CDS), automatic gain control (AGC), and analog-to-digital conversion in the imaging signal processing circuit 63, and is then inputted to the DSP 61. In the DSP 61, the input signals are subjected to predetermined color processing and signal processing such as gamma correction, and as a result, live view image data (that is, luminance signal data Y and two color-difference signal data Cr and Cb) is generated. Since the number of pixels of the live view image data depends on the number of display pixels of the display 15, it is smaller than the effective number of pixels of the CCD 16 (that is, data is thinned out). The display 15 displays a live view image based on the live view image data. Processing for generating live view image data is cyclically updated together with the readout of signals from the CCD 16 so that the display 15 can display a motion image in real time.

On the other hand, at the time of photographing, the ground-based telescope body 1 is operated in the following manner. The release button 42 is pressed to turn on the release switch (not shown in the drawings) so that the CPU 60 directs the DSP 61 to perform main exposure. Under the instructions from the CPU 60, the DPS 61 controls the discharging of undesired charge and the charge accumulation period (that is, the exposure period) of the CCD 16, reads out charge data from the CCD 16 through the imaging signal processing circuit 63 in the same manner as described above without thinning out pixels, and allows the SDRAM 62 to temporarily keep the charge data. Then, the DSP 61 reads out the charge data from the SDRAM 62, and subjects the charge data to predetermined signal processing to generate still original image data for recording purpose having a large amount of pixel data.

Further, the DSP 61 subjects the generated still original image data for recording purpose to thinning processing, to generate a screennail of a still image for display purpose (e.g., 640×480 pixels). The display 15 displays the screennail for a predetermined period of time. Furthermore, the DSP 61 subjects the generated still original image data for recording purpose to image data compression processing in the JPEG circuit 65, and then allows the resulting compressed image data to be outputted through the memory interface 66 to record it onto the memory card 100.

As described above, the ground-based telescope 10 has a long focal length of the objective optical system 11. Since the effect of longitudinal chromatic aberration increases with focal length, significant longitudinal chromatic aberration for blue and red lights occurs in the ground-based telescope 10. However, a user does not recognize such longitudinal chromatic aberration when observes an object through the eyepiece 2. The reason for this is as follows. As can be seen from the graph of spectral luminous efficiency of the human eye (that is, the spectral luminous efficiency in bright light) shown in FIG. 8, the human eye is most sensitive to green light having a wavelength of 555 nm, but is not so sensitive to blue light having short wavelengths and red light having long wavelengths. Therefore, even if significant longitudinal chromatic aberration for blue and red lights occurs, it is imperceptible to the human eye. That is, in observing an object through the eyepiece 2, occurrence of significant longitudinal chromatic aberration for blue and red lights does not become a problem.

However, as can be seen from FIG. 8, an imaging device such as the CCD 16 is sensitive to blue and red lights. Therefore, color blur appears in an image taken by the CCD 16 under the influence of longitudinal chromatic aberration. Since red light is absorbed by the IR cut filter 174, color blur caused by longitudinal chromatic aberration for red light is not so conspicuous. However, there is a problem that a conventional telescope with digital imaging capability does not have a UV cut filter such as the UV cut filter 175, and therefore blue blur or purple blur appears in an image taken by the CCD 16 under the influence of longitudinal chromatic aberration for blue light.

In order to overcome such a problem, in the present invention, the UV cut filter 175 is provided as a UV eliminator to eliminate light, having wavelengths causing blue blur or purple blur, from light toward the CCD 16, thereby enabling color blur to be prevented. As a result, the CCD 16 can take a clear and high quality image. Further, since such a structure as described above is achieved at a relatively low cost, the effect of the present invention can be obtained without a great increase in cost.

Further, in the present embodiment, since the UV cut filter 175 is provided on the optical path between the beam splitter 56 and the CCD 16, especially between the reduction optical system 18 and the CCD 16, it is not necessary for the UV cut filter 175 to be large in size. This makes it possible to manufacture the ground-based telescope body 1 at a relatively low cost, simplify the structure thereof, and reduce the size thereof. Furthermore, in the present embodiment, the UV cut filter 175, the optical lowpass filters 171, 172, and 173, and the IR cut filter 174 are laminated, which also makes it possible to simplify the structure of the ground-based telescope body 1 and reduce the size thereof.

In the present invention, it is to be noted that the position of the UV eliminator such as the UV cut filter 175 is not particularly limited. For example, the UV eliminator may be provided in the vicinity of the objective optical system 11, the focus lens 31, the prism unit 5 or the reduction optical system 18. Further, the UV eliminator is not limited to a UV cut filter. For example, the UV eliminator may be an optical thin film provided on the surface of the objective optical system 11, the focus lens 31, the prism unit 5, or the reduction optical system 18. Furthermore, the UV eliminator is not limited to one which eliminates UV by absorbing light having specific wavelengths, such as the UV cut filter 175. For example, the UV eliminator may be one which eliminates UV by preventing reflection of light having specific wavelengths or one which eliminates UV by combination of absorption and reflection.

In the ground-based telescope 10 of the present embodiment, the eyepiece 2 can be detachably attached to the ground-based telescope body 1 so as to be replaced with another one, but the present invention is not limited thereto. For example, the ground-based telescope 10 may be one in which an eyepiece is integrally formed with a ground-based telescope body (that is, an eyepiece cannot be replaced with another one).

The scope of application of the present invention is not limited to ground-based telescopes. The present invention can be applied to various kinds of telescopes including astronomical telescopes.

It should be noted that the present invention is not limited to the ground-based telescope body and the ground-based telescope described with reference to the embodiment shown in the drawings, and so long as the same functions are achieved, it is possible to make various changes and additions to each portion of the ground-based telescope body and the ground-based telescope of the present invention.

Further, it is also to be understood that the present disclosure relates to subject matter contained in Japanese Patent Application No. 2003-353814 filed on Oct. 14, 2003 which is expressly incorporated herein by reference in its entireties.

1. A telescope body, comprising:
an objective optical system;
a focus adjuster provided with a focus adjusting member which is operated for achieving focusing and a focus lens which is moved along the optical axis by operating the focus adjusting member;
an imaging device for capturing an image formed by at least the objective optical system and the focus lens; and
a UV eliminator for eliminating light having wavelengths in the vicinity of ultraviolet light contained in light that enters the imaging device.

2. The telescope body as claimed in claim 1, wherein the UV eliminator eliminates 50% or more of light having wavelengths of 430 nm or less.

3. The telescope body as claimed in claim 1, further comprising a beam splitter which divides light that has passed through the focus lens into an optical path toward an eyepiece optical system and an optical path toward the imaging device, wherein the UV eliminator is provided on the optical path between the beam splitter and the imaging device.

4. The telescope body as claimed in claim 1, further comprising a beam splitter 56 which divides light that has passed through the focus lens into an optical path toward an eyepiece optical system and an optical path toward the imaging device, and an image-forming optical system provided on the optical path between the beam splitter and the imaging device for forming an image on a light-receiving surface of the imaging device based on beams of the light from the beam splitter.

5. The telescope body as claimed in claim 4, wherein the UV eliminator is provided on the optical path between the imaging optical system and the imaging device.

6. The telescope body as claimed in claim 1, wherein the UV eliminator includes an optical filter provided in the vicinity of a light-receiving surface of the imaging device.

7. The telescope body as claimed in claim 6, further comprising an optical lowpass filter and/or an IR cut filter provided in the vicinity of a light-receiving surface of the imaging device, wherein the optical filter is laminated on the optical lowpass filter and/or the IR cut filter.

8. The telescope body as claimed in claim 1, wherein an imaging optical system for the imaging device is constructed from all of optical systems arranged between the objective optical system and a light-receiving surface of the imaging device, and the focal length of the imaging optical system is 800 mm or longer converted into 35 mm film format.

9. A telescope comprising a telescope body as claimed in claim 1 and an eyepiece optical system provided on the telescope body.
